(19) United States
(12) Patent Application Publication
(10) Pub. No.: US 2012/0180063 A1
(43) Pub. Date: Jul. 12, 2012

(54) Method and Apparatus for Providing Management of Parallel Library Implementation

(75) Inventors: Steven James RAWLINGS, South Hampton (GB); Mark HAMBLETON, Surrey (GB)

(73) Assignee: NOKIA CORPORATION, Espoo (FI)

(21) Appl. No.: 13/303,611

(22) Filed: Nov. 23, 2011

Related U.S. Application Data
(60) Provisional application No. 61/417,094, filed on Nov. 24, 2010.

(51) Int. Cl. G06F 9/46

(52) U.S. Cl. 718/104

(57) ABSTRACT

A method for providing management of parallel library implementations relative to available resources may include receiving an indication of a registration of a parallel library and determining processor utilization information based on current load conditions. The processor utilization information may be indicative of a number of processors to be made available to the parallel library for a process associated with the parallel library. The method may further include causing provision of the processor utilization information to the parallel library. A corresponding apparatus is also provided.

### RELATED APPLICATIONS

This application claims priority to U.S. Provisional Patent Application No. 61/417,094, filed Nov. 24, 2010, which is hereby incorporated herein in its entirety by reference.

### TECHNOLOGICAL FIELD

An embodiment of the present invention relates generally to resource management technology and, more particularly, relates to a method and apparatus for providing management of parallel library implementations.

### BACKGROUND

The modern communications era has brought about a tremendous expansion of wireline and wireless networks. Computer networks, television networks, and telephony networks are experiencing an unprecedented technological expansion, fueled by consumer demand. Networking technologies have addressed related consumer demands, while providing more flexibility and immediacy of information transfer.

Current and future networking technologies continue to facilitate ease of information transfer and convenience to users by expanding the capabilities of electronic devices and by improving network performance. One advance that has improved the capabilities of electronic devices to provide services and processing to users is the use of parallel computing. Parallel computing involves either the user of multiple processors or multi-core processors in a single device or multiple processors distributed over different devices to perform computing operations such as calculations, computations or other processing efforts using the parallel resources of the processors involved. Thus, for example, some threads may be processed on one processor or core, while other threads may be simultaneously processed on another processor or core.

Significant increases in speed and processing capabilities may be added to devices or systems that employ parallel computing. Accordingly, in the absence of space, cost and power consumption limitations, it may otherwise be desirable to continue to add additional processors or cores to continue to increase the processing capabilities of devices. However, the limitations described above are very common in real world devices. Moreover, for mobile electronic devices, the limitations tend to be more acute than may be experienced in some other environments.

Accordingly, it may be desirable to manage the computing resources and power resources in parallel computing environments in some cases.

### BRIEF SUMMARY

A method, apparatus and computer program product are therefore provided to enable management of parallel library implementations. In this regard, for example, some embodiments may provide for the registration of a parallelization class library with a resource manager configured to manage power and/or processing resources. Once registered, the library may receive information indicative of the number of processors (e.g., cores in a multi-core environment or processing devices in a multi-processor environment) available to the library from the resource manager. In some examples, the resource manager may provide indications of increasing or decreasing the numbers of available processors based on current conditions in order to control power consumption and computation loading.

In one example embodiment, a method of providing management of parallel library implementations relative to available resources is provided. The method may include receiving an indication of a registration of a parallel library and determining processor utilization information based on current load conditions. The processor utilization information may be indicative of a number of processors to be made available to the parallel library for a process associated with the parallel library. The method may further include causing provision of the processor utilization information to the parallel library.

In another example embodiment, an apparatus for providing management of parallel library implementations relative to available resources is provided. The apparatus may include at least one processor and at least one memory including computer program code. The at least one memory and the computer program code may be configured to, with the at least one processor, cause the apparatus to perform at least receiving an indication of a registration of a parallel library, determining processor utilization information based on current load conditions, and causing provision of the processor utilization information to the parallel library. The processor utilization information may be indicative of a number of processors to be made available to the parallel library for a process associated with the parallel library.

In one example embodiment, another apparatus for providing management of parallel library implementations relative to available resources is provided. The apparatus may include means for receiving an indication of a registration of a parallel library and means for determining processor utilization information based on current load conditions. The processor utilization information may be indicative of a number of processors to be made available to the parallel library for a process associated with the parallel library. The apparatus may further include means for causing provision of the processor utilization information to the parallel library.

In one example embodiment, a computer program product for providing management of parallel library implementations relative to available resources is provided. The computer program product may include at least one computer-readable storage medium having computer-executable program code instructions stored therein. The computer-executable program code instructions may include program code instructions for receiving an indication of a registration of a parallel library, determining processor utilization information based on current load conditions, and causing provision of the processor utilization information to the parallel library. The processor utilization information may be indicative of a number of processors to be made available to the parallel library for a process associated with the parallel library.

In another example embodiment, an alternative method of providing management of parallel library implementations relative to available resources is provided. The method may include registering a parallel library with a resource manager configured to manage loading for a plurality of processors and receiving processor utilization information from the resource manager based on current load conditions. The processor utilization information may be indicative of a number of processors to be made available to the parallel library for a process associated with the parallel library. The method may further include utilizing the processor or processors made available to the parallel library for starting a processing activity.

An example embodiment of the invention may provide a method, apparatus and computer program product for employment in mobile environments or in fixed environments. As a result, for example, mobile terminal and other computing device users may enjoy an improved management of processes in consideration of available power and computing resources.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 is a schematic block diagram of a wireless communications system according to an example embodiment of the present invention;

FIG. 2 illustrates a block diagram of an apparatus for providing management of parallel library implementations according to an example embodiment of the present invention;

FIG. 3 is a flowchart according to an example method for providing management of parallel library implementations according to an example embodiment of the present invention; and

FIG. 4 is a flowchart according to an example method for providing management of parallel library implementations according to another example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of management of parallel library implementations relative to available resources. In some cases, such as in mobile environments and even in some fixed environments, computing resources and/or power may be at a premium. For example, mobile terminals typically draw power from a battery that requires recharging periodically. The rate of power consumption for such devices is obviously determinative of how frequently battery recharging operations must be conducted. Although parallel computing can greatly increase the processing capabilities of a device or system with access to the use of multiple processors (e.g., cores in a multi-core environment or processing devices in a multi-processor environment) for parallel computing also increases the rate of power consumption. Accordingly, some embodiments of the present invention may enable management of the use of multiple processors for parallel computing in order to manage power and computing resources. Thus, for example, some embodiments may provide a parallelization class library that facilitates thread agnostic source code while allowing an operating system (or component thereof) to dynamically increase or reduce power and/or computing load conditions based on environmental factors such as current power and/or processing load conditions.

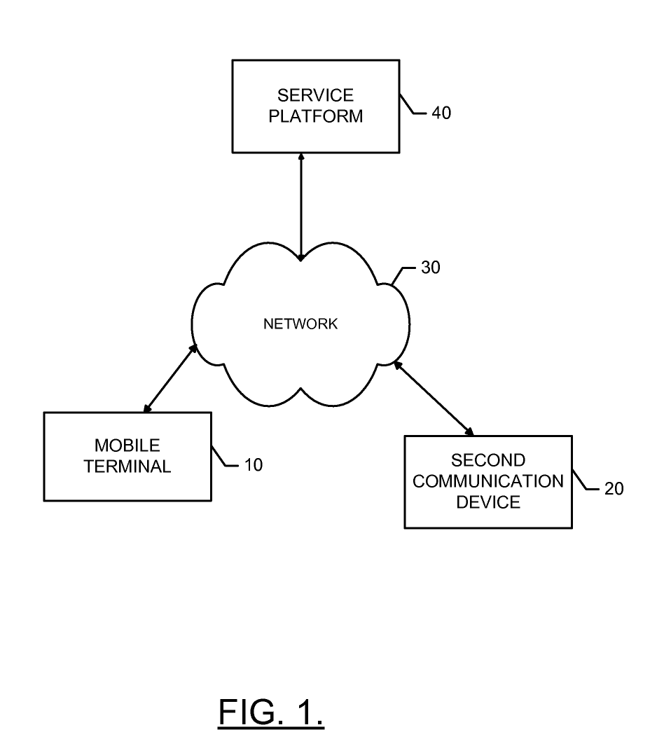

FIG. 1 illustrates a generic system diagram in which a device such as a mobile terminal 10, which may benefit from some embodiments of the present invention, is shown in an example communication environment. As shown in FIG. 1, a system in accordance with an example embodiment of the present invention includes a first communication device (e.g., mobile terminal 10) and a second communication device 20 that may each be capable of communication with a network 30. The second communication device 20 is provided as an example to illustrate potential multiplicity with respect to instances of other devices that may be included in the network 30 and that may practice an example embodiment. The communications devices of the system may be able to communicate with network devices or with each other via the network 30. In some cases, the network devices with which the communication devices of the system communicate may include a service platform 40. In an example embodiment, the mobile terminal 10 (and/or the second communication device 20) is enabled to communicate with the service platform 40 to provide, request and/or receive information.

While an example embodiment of the mobile terminal 10 may be illustrated and hereinafter described for purposes of example, numerous types of mobile terminals, such as portable digital assistants (PDAs), pagers, mobile televisions, mobile telephones, gaming devices, laptop computers, cameras, camera phones, video recorders, audio/video player, radio, GPS devices, navigation devices, or any combination of the aforementioned, and other types of voice and text communications systems, may readily employ an example embodiment of the present invention. Furthermore, devices that are not mobile may also readily employ an example embodiment of the present invention. As such, for example, the second communication device 20 may represent an example of a fixed electronic device that may employ an example embodiment. For example, the second communication device 20 may be a personal computer (PC) or other terminal.

In some embodiments, not all systems that employ embodiments of the present invention may comprise all the devices illustrated and/or described herein. For example, while an example embodiment will be described herein in which either a mobile user device (e.g., mobile terminal 10), a fixed user device (e.g., second communication device 20), or a network device (e.g., the service platform 40) may include an apparatus capable of performing some example embodiments in connection with communication with the network 30, it should be appreciated that some embodiments may exclude one or multiple ones of the devices or the network 30 altogether and simply be practiced on a single device (e.g., the mobile terminal 10 or the second communication device 20) in a stand alone mode.

Thus, for example, in embodiments where one or more of the mobile terminal 10, the second communication device 20 and the service platform 40 have multiple processors associated therewith, an example embodiment may be practiced on such a multi-processor device without any communication with the network 30 or with other devices. However, in embodiments where the network 30 is employed, an apparatus located, for example, at the service platform 40 could perhaps manage the power consumption and computing load of the processors of multiple devices (e.g., the mobile terminal 10, the second communication device 20 and the service platform 40) employing an example embodiment of the present invention.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be capable of communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the second communication device 20 via the network 30. By directly or indirectly connecting the mobile terminal 10, the second communication device 20 and other devices to the network 30, the mobile terminal 10 and the second communication device 20 may be enabled to communicate with the other devices (or each other), for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing device. The service platform 40 may have any number of functions or associations with various services. As such, for example, the service platform 40 may be a platform such as a dedicated server (or server bank) associated with a particular information source or service (e.g., a power and/or computing load management service), or the service platform 40 may be a backend server associated with one or more other functions or services. As such, the service platform 40 represents a potential host for a plurality of different services or information sources. In some embodiments, the functionality of the service platform 40 is provided by hardware and/or software components configured to operate in accordance with known techniques for the provision of information to users of communication devices. However, at least some of the functionality provided by the service platform 40 may be information provided in accordance with an example embodiment of the present invention.

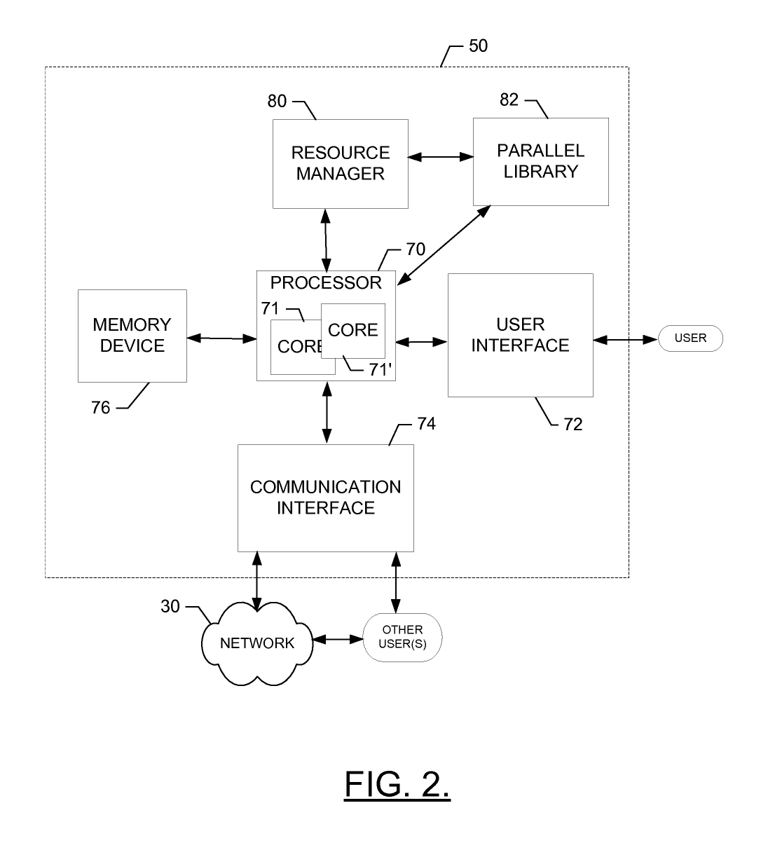

FIG. 2 illustrates a schematic block diagram of an apparatus for providing management of parallel library implementations relative to available resources according to an example embodiment of the present invention. An example embodiment of the invention will now be described with reference to FIG. 2, in which certain elements of an apparatus 50 for providing management of parallel library implementations relative to available resources are displayed. The apparatus 50 of FIG. 2 may be employed, for example, on the service platform 40, on the mobile terminal 10 and/or on the second communication device 20. However, the apparatus 50 may alternatively be embodied at a variety of other devices, both mobile and fixed (such as, for example, any of the devices listed above). In some cases, an embodiment may be employed on either one or a combination of devices. Accordingly, some embodiments of the present invention may be embodied wholly at a single device (e.g., the service platform 40, the mobile terminal 10 or the second communication device 20), by a plurality of devices in a distributed fashion or by devices in a client/server relationship (e.g., the mobile terminal 10 and the service platform 40). Furthermore, it should be noted that the devices or elements described below may not be mandatory and thus some may be omitted in certain embodiments.

Referring now to FIG. 2, an apparatus for providing management of parallel library implementations relative to available resources is provided. The apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10 or the second communication device 20), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

Although an example embodiment will now be described in the context of a multi-core processor, it should be appreciated that some embodiments may also be practiced in environments where multiple processors are networked together, as described above. In an example embodiment, the processor 70 may be a multi-core processor with two, four, six, eight, or any desirable number of cores. Each of the multiple processor cores (represented by cores 71 and 71′) may represent a portion of the processor 70 that actually read and executes instructions. Moreover, in an example embodiment, the cores 70 and 71′ (along with other cores if more than two cores are implemented) may execute code or threads in parallel. In this regard, in some cases, parallel libraries may be employed to provide standard implementations and patterns for enabling code to be written in a portable way that can be scaled depending on the number of processors available in a particular environment as described in greater detail below.

In an exemplary embodiment, the processor 70 may be embodied as, include or otherwise control a resource manager 80, and at least one parallel library 82. As such, in some embodiments, the processor 70 may be said to cause, direct or control the execution or occurrence of the various functions attributed to the resource manager 80 and the parallel library 82 as described herein. The resource manager 80 and the parallel library 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the resource manager 80 and the parallel library 82, respectively, as described herein. Thus, in examples in which software is employed, a device or circuitry (e.g., the processor 70 in one example) executing the software forms the structure associated with such means.

In an example embodiment, the resource manager 80 may generally be configured to manage power policies for the apparatus 50. As such, the resource manager 80 may be configured to make power and/or load management decisions based on the current state of the apparatus (e.g., with respect to power consumption, state of battery charge and/or current processing load). The resource manager 80 may also be configured to receive registrations from parallel libraries (e.g., parallel library 82) that may request information regarding the number of processors (e.g., cores) available for use in implementing parallelism. The registration of the parallel library 82 with the resource manager 80 may be accomplished via any suitable operating system specific interprocess communication technology. This component may be in user space or in kernel space.

The resource manager 80 may be configured to receive information regarding processor loading (e.g., power load and/or computation load) and perhaps also device state (e.g., battery state of charge or other information indicative of available power or desired power use parameters). In some alternatives, the resource manager 80 may receive the information directly or indirectly from sensors or may extract or request the information from other sources. The resource manager 80 may be configured to utilize the processor loading information and/or the device state information to make determinations as to the number of processor cores (e.g., one or both of cores 71 and 71′ in this example) to be made available to the parallel library 82 when the parallel library 82 registers with the resource manager 80. For example, if ample power is available (e.g., a full state of charge or state of charge above a particular threshold, or power loading being below a threshold), the resource manager 80 may inform a registering parallel library that both cores 71 and 71′ (or in multi-core environments with more processors, a higher number of processors) are available for implementing parallelism. Meanwhile, for example, if insufficient power is available (e.g., due to state of charge being below a particular threshold or power loading being above a threshold), the resource manager 80 may be configured to indicate that only one core (e.g., core 71 or 71′) is to be made available to the parallel library 82 when the parallel library 82 registers with the resource manager 80. Similar allocations or indications may be made on the basis of core processing load. Accordingly, the resource manager 80 may be configured to increase or decrease the amount of parallelism being attempted in the apparatus 50 based on current conditions.

The parallel library 82 may be one example (perhaps of a plurality of parallel libraries) of an entity configured to provide standard implementations and patterns to allow parallelism to be implemented on code or threads to be executed. Thus, for example, data access, storage and processing functions may be implemented in parallel via the parallel library 82 by abstracting multithreaded implementation using language specific constructs (e.g., using lambdas in C++).

As indicated above, the parallel library 82 may register with the resource manager 80 for each process associated with the parallel library 82. The parallel library 82 may then receive processor utilization information indicative of the number and perhaps also the identities of the processors (e.g., cores 71 and/or 71′) that are available to the parallel library 82 for execution of a particular process associated with the parallel library 82. The resource manager 80 may provide the processor utilization information to the parallel library 82, responsive to registration, in the form of either a direct value or number of processors that are available to the parallel library 82 for use in balancing the workload of the parallel library 82 against. However, in some embodiments, the resource manager 80 may provide a cached value that may be referenced to determine the number of processors available for any processing activity that is to be started or initiated by the parallel library 82. In an example embodiment, once a particular number of processors have been allocated or otherwise made available to the parallel library 82, the parallel library 82 may be enabled (or even required) to complete the corresponding activity or process associated with which the particular number of processors was assigned before any change to the amount of processors utilized by the parallel library 82 may be implemented. In other words, once set of resources has been assigned to the parallel library 82 for a processing activity to be started, the processing activity may be entitled (or required) to proceed to completion using the assigned resources before a change to the set of resources for processing activities associated with the parallel library 82 may be implemented due to updated processor utilization information. However, allocations of future resources may be reduced or increased accordingly, based on current conditions when such allocations are made.

According to an example embodiment, the resource manager 80 may be responsible for monitoring load and power thresholds in order to implement policies by which a number of cores may be published to a parallel library for processes to be executed. The number of cores (or more generically, the number of processors) may be increased or decreased based on current conditions. As indicated above, the number of cores may be provided via processor utilization information. During initialization, the resource manager 80 may query the system (or apparatus 50) to determine current loading conditions (e.g., power and/or processing load). Thereafter, the resource manager 80 may monitor conditions relative to any power and/or processing load thresholds that may be established to guide the allowable allocations of processors to activities or processes that are initiated subsequently. As such, the resource manager 80 may be configured to upgrade or downgrade the amount of parallelism that the parallel library 82 is enabled to attempt to employ. The upgrading or downgrading may be accomplished by the provision of updates to the processor utilization information in response to new processor utilization information being available or determined.

In the example of FIG. 2, if the apparatus 50 is embodied as the mobile terminal 10 and the battery of the mobile terminal 10 is low, the resource manager 80 (which may act as a power server) may determine that processes should run on only one of the cores 71 or 71′ to improve efficiency and conserve battery power. As such, the resource manager 80 may only make one core available to processing activities that are started for the time being in order to manage the amount of parallelism that is employed. If one or more of the cores 71 or 71′ is being overloaded computationally, the resource manager 80 may also be configured to reduce the overhead of parallelism in order to make the apparatus 50 run more efficiently. To do this, the resource manager 80 may use the same operating system interprocess communication method to publish a new (reduced in this case) number of cores to registered clients where the parallel library 82 may balance any subsequent processing activity undertaken over the newly available number of cores.

In some cases, it may be possible to employ the functionalities described above in order to have processes employing the parallel library 82 allocated to a particular domain upon registering. This may be accomplished either by directly requesting a domain, or the resource manager 80 may determine a domain based on metadata that may be available thereat. As such, the resource manager 80 may be configured to restrict parallelism to a specific type of process such as, for example, managing the number of cores available to installed applications while maintaining a constant number of cores available for processes associated with the native operating system.

In an example embodiment, an extension may be made to the mechanism described above in order to allow instances of the parallel library 82 to be uniquely identifiable by a process identifier. Accordingly, for example, the apparatus 50 may be enabled to attempt to throttle an implementation that is proving to be disruptive to the stability of the operating system of the apparatus 50.

Some embodiments may therefore provide parallel libraries in an embedded environment to enable control by the operating system provider with respect to the actual implementation to mitigate the likelihood that a particular process associated with the implementation can make extensive requests on the resources of the apparatus 50. Furthermore, by providing the ability to manage resources in a domain based fashion, some example embodiments may be enabled to restrict parallelism to selected types of processes. Thus, for example, the operating system (via the resource manager 80) may be enabled to provide a hierarchy of parallelism that can manage core resources in a balanced way. In response to high loading conditions, the resource manager 80 may re-target the amount of parallelism to process parallelism rather than task parallelism. Accordingly, for example, a softer mechanism for enabling an operating system to manage resources is provided than simply killing misbehaving processes. Instead, by restricting the number of cores available to some processes, a throttling effect may be realized.

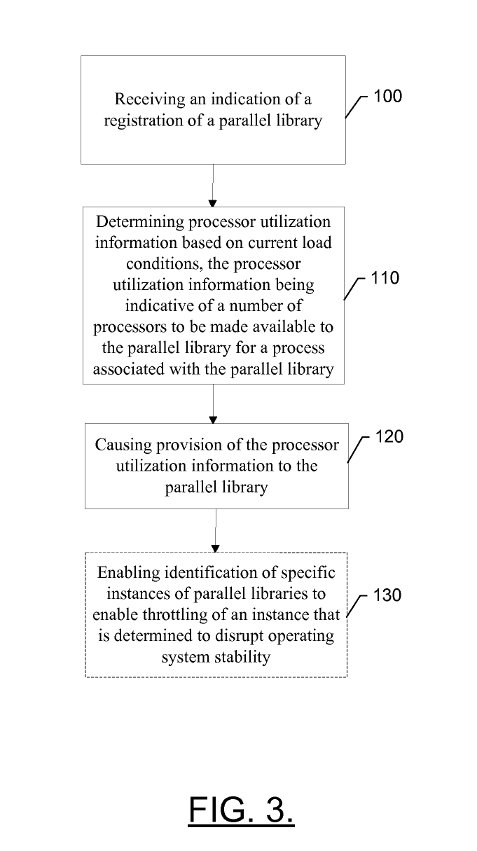

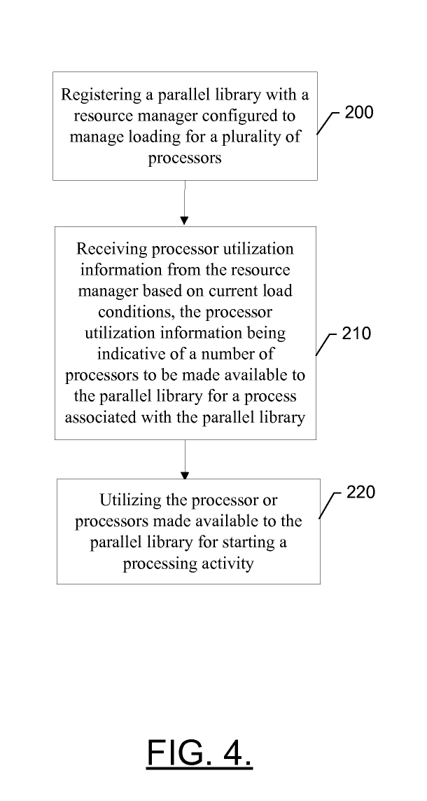

FIGS. 3 and 4 are flowcharts of a method and program product according to an example embodiment of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or network device and executed by a processor in the user terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowcharts block(s). These computer program instructions may also be stored in a computer-readable memory that may direct a computer or other programmable apparatus to function in a particular manner, such that the instructions stored in the computer-readable memory produce an article of manufacture which implements the functions specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In this regard, a method according to one embodiment of the invention, as shown in FIG. 3, may include receiving an indication of a registration of a parallel library at operation 100 and determining processor utilization information based on current load conditions at operation 110. Current load conditions may be understood to be both those conditions occurring right now as well as those occurring in the recent past. In other words, current load conditions may be those load conditions that are temporally proximate to the time at which processor utilization information is determined. The processor utilization information may be indicative of a number of processors to be made available to the parallel library for a process associated with the parallel library. The method may further include causing provision of the processor utilization information to the parallel library at operation 120.

In some embodiments, certain ones of the operations above may be modified or further amplified as described below. Moreover, in some embodiments additional optional operations may also be included (an example of which is shown in dashed lines in FIG. 3). It should be appreciated that each of the modifications, optional additions or amplifications below may be included with the operations above either alone or in combination with any others among the features described herein. In this regard, for example, the method may further include enabling identification of specific instances of parallel libraries to enable throttling of an instance that is determined to disrupt operating system stability at operation 130. In an example embodiment, determining processor utilization information may include determining the number of processors to be made available based on power load conditions of an apparatus associated with a plurality of processors, based on processing load conditions of each of the plurality of processors or based on a state of charge of a battery of the apparatus associated with the plurality of processors. In some embodiments, causing provision of the processor utilization information may include causing provision of a value indicative of the number of processors or causing provision of a cached value providing information indicative of the number of processors. In some cases, determining processor utilization information may be performed at least periodically and an update in a processor utilization information determination may trigger updated provision of processor utilization information to the parallel library. In an example embodiment, causing provision of the processor utilization information may include causing provision of processor utilization information associated with a particular domain.

In an example embodiment, an apparatus for performing the method of FIG. 3 above may comprise a processor (e.g., the processor 70) configured to perform some or each of the operations (100-130) described above. The processor may, for example, be configured to perform the operations (100-130) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-130 may comprise, for example, the processor 70, the resource manager 80 and/or a device or circuitry for executing instructions or executing an algorithm for processing information as described above.

In another example embodiment, an alternative method of providing management of parallel library implementations relative to available resources is provided. The method may include registering a parallel library with a resource manager configured to manage loading for a plurality of processors at operation 200 and receiving processor utilization information from the resource manager based on current load conditions at operation 210. The processor utilization information may be indicative of a number of processors to be made available to the parallel library for a process associated with the parallel library. The method may further include utilizing the processor or processors made available to the parallel library for starting a processing activity at operation 220.

In some embodiments, certain ones of the operations above may be modified or further amplified as described below. It should be appreciated that each of the modifications or amplifications below may be included with the operations above either alone or in combination with any others among the features described herein. In this regard, for example, receiving processor utilization information may include receiving information indicative of the number of processors to be made available based on power load conditions of an apparatus associated with a plurality of processors, based on processing load conditions of each of the plurality of processors, or based on a state of charge of a battery of the apparatus. In some cases, receiving processor utilization information comprises at least periodically receiving updated processor utilization information or receiving processor utilization information associated with a particular domain.

In some cases, the operations (200-220) described above, along with any of the modifications may be implemented in a method that involves facilitating access to at least one interface to allow access to at least one service via at least one network. In such cases, the at least one service may be said to perform at least operations 200 to 220.

In an example embodiment, an apparatus for performing the method of FIG. 4 above may comprise a processor (e.g., the processor 70) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-220 may comprise, for example, the processor 70, the parallel library 82, and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a registration of a parallel library;
determining processor utilization information based on current load conditions, the processor utilization information being indicative of a number of processors to be made available to the parallel library for a process associated with the parallel library; and
causing provision of the processor utilization information to the parallel library.

2. The method of claim 1, wherein determining processor utilization information comprises determining the number of processors to be made available based on power load conditions of an apparatus associated with a plurality of processors.

3. The method of claim 1, wherein determining processor utilization information comprises determining the number of processors to be made available based on processing load conditions of each of a plurality of processors.

4. The method of claim 1, wherein determining processor utilization information comprises determining the number of processors to be made available based on a state of charge of a battery of an apparatus associated with a plurality of processors.

5. The method of claim 1, wherein causing provision of the processor utilization information comprises causing provision of a value indicative of the number of processors.

6. The method of claim 1, wherein causing provision of the processor utilization information comprises causing provision of a cached value providing information indicative of the number of processors.

7. The method of claim 1, wherein determining processor utilization information is performed at least periodically and wherein an update in a processor utilization information determination triggers updated provision of processor utilization information to the parallel library.

8. The method of claim 1, wherein causing provision of the processor utilization information comprises causing provision of processor utilization information associated with a particular domain.

9. The method of claim 1, further comprising enabling identification of specific instances of parallel libraries to enable throttling of an instance that is determined to disrupt operating system stability.

10. An apparatus comprising at least one processor and at least one memory including computer program code, the at least one memory and the computer program code configured to, with the at least one processor, cause the apparatus at least to:
receive an indication of a registration of a parallel library;
determine processor utilization information based on current load conditions, the processor utilization information being indicative of a number of processors to be made available to the parallel library for a process associated with the parallel library; and
cause provision of the processor utilization information to the parallel library.

11. The apparatus of claim 10, wherein the at least one memory and computer program code are configured to, with the at least one processor, cause the apparatus to determine processor utilization information by determining the number of processors to be made available based on power load conditions of an apparatus associated with a plurality of processors or based on processing load conditions of each of the plurality of processors.

12. The apparatus of claim 10, wherein the at least one memory and computer program code are configured to, with the at least one processor, cause the apparatus to determine processor utilization information by determining the number of processors to be made available based on a state of charge of a battery of an apparatus associated with a plurality of processors.

13. The apparatus of claim 10, wherein the at least one memory and computer program code are configured to, with the at least one processor, cause the apparatus to cause provision of the processor utilization information by providing a value indicative of the number of processors or providing a cached value providing information indicative of the number of processors.

14. The apparatus of claim 10, wherein the at least one memory and computer program code are configured to, with the at least one processor, cause the apparatus to determine processor utilization information at least periodically and wherein an update in a processor utilization information determination triggers updated provision of processor utilization information to the parallel library.

15. The apparatus of claim 10, wherein the at least one memory and computer program code are configured to, with the at least one processor, cause the apparatus to cause provision of the processor utilization information by providing processor utilization information associated with a particular domain.

16. The apparatus of claim 10, wherein the at least one memory and computer program code are further configured to, with the at least one processor, cause the apparatus to enable identification of specific instances of parallel libraries to enable throttling of an instance that is determined to disrupt operating system stability.

17. The apparatus of claim 10, wherein the apparatus is a mobile terminal and further comprises user interface circuitry configured to facilitate user control of at least some functions of the mobile terminal.

18. A method comprising:
registering a parallel library with a resource manager configured to manage loading for a plurality of processors;
receiving processor utilization information from the resource manager based on current load conditions, the processor utilization information being indicative of a number of processors to be made available to the parallel library for a process associated with the parallel library; and
utilizing a processor or processors made available to the parallel library for starting a processing activity.

19. The method of claim 18, wherein receiving processor utilization information comprises receiving information indicative of the number of processors to be made available based on power load conditions of an apparatus associated with a plurality of processors, based on processing load conditions of each of the plurality of processors, or based on a state of charge of a battery of the apparatus.

20. The method of claim 18, wherein receiving processor utilization information comprises at least periodically receiving updated processor utilization information or receiving processor utilization information associated with a particular domain.
